(19) United States
(12) Patent Application Publication
(10) Pub. No.: US 2011/0110610 A1
(43) Pub. Date: May 12, 2011

(54) IMAGE READING APPARATUS, IMAGE READING SYSTEM, AND IMAGE READING METHOD

(75) Inventor: Hiroyuki Hashiguchi, Kagoshima-shi (JP)

(73) Assignee: SEIKO EPSON CORPORATION, Shinjuku-ku (JP)

(21) Appl. No.: 12/942,941

(22) Filed: Nov. 9, 2010

(30) Foreign Application Priority Data
Nov. 10, 2009 (JP) 2009-256781

(51) Int. Cl. G06K 7/10

(52) U.S. Cl. 382/321

(57) ABSTRACT

An image reading apparatus includes an image reading unit which reads a manuscript image by optically scanning a manuscript placed on a reading region, a region division unit which divides the reading region into a plurality of partial regions in accordance with a division direction directed along a sub scanning direction to which the image reading unit moves for scanning the manuscript and a division direction directed along a main scanning direction perpendicular to the sub scanning direction, a condition setting unit which sets a condition on which the image reading unit reads the manuscript image for each of the partial regions, and a controller which directs the image reading unit to read the manuscript image on the conditions depending on the partial regions being scanned by the image reading unit.

### CROSS REFERENCES TO RELATED APPLICATIONS

The present invention contains subject matter related to Japanese Patent Application No. 2009-256781 filed in the Japanese Patent Office on Nov. 10, 2009, the entire contents of which are incorporated herein by reference.

### BACKGROUND

1. Technical Field

The present invention relates to an image reading apparatus, an image reading system and an image reading method.

2. Related Art

A scanner as an image reading apparatus which optically scans a manuscript by using an image sensor, and reads an image of the manuscript has been widely spread. In such a scanner, an optical system which includes a light source and an image sensor is arranged on a carriage moving in a predetermined direction as described in JP-A-2009-17022. Further, in such a scanner as described in JP-A-2009-17022, a reading range is defined by a reference pattern or the like which can be identified by the carriage which moves to read a manuscript in the reading range. A user sets a reading condition before a manuscript set on a scanner is read, and then, directs the scanner to read the manuscript so that an image of the manuscript read on a desired condition can be obtained.

However, such a scanner reads a manuscript within a reading range on the same reading condition. Therefore, when documents and pictures are mixedly present on one manuscript and the documents and pictures are desired to be read on different reading conditions from each other, the following operations are required. That is, operations in which the manuscript is repeatedly read on each of the different reading conditions, then, desired regions are cut out from images of the manuscript which are obtained by reading on the different reading conditions and the cut-out images are edited are required. Therefore, a lot of effort and time are needed.

### SUMMARY

An advantage of some aspects of the invention is to provide a technique for making a reading process performed on a manuscript effective and reducing labor of a user.

Aspects of the invention are made in order to solve at least one of the issues mentioned above and can be realized in the following forms or as Application Examples.

### Application Example 1

An image reading apparatus according to the Application Example includes an image reading unit which reads a manuscript image by optically scanning a manuscript placed on a reading region, a region division unit which divides the reading region into a plurality of partial regions, a condition setting unit which sets a condition on which the image reading unit reads the manuscript image for each of the partial regions, and a controller which directs the image reading unit to read the manuscript image on the conditions depending on the partial regions being scanned by the image reading unit.

With this configuration, a reading region where the image reading unit reads a manuscript image is divided into a plurality of partial regions and a condition on which the manuscript image is read is set for each of the partial regions. Accordingly, the manuscript image is read on the reading conditions set for each of the partial regions with one reading operation. Therefore, a manuscript in which documents and pictures are mixedly present is effectively read and a user's labor can be reduced.

### Application Example 2

In the image reading apparatus according to the Application Example, it is preferable that the region division unit divide the reading region in accordance with a division direction directed along a sub scanning direction to which the image reading unit moves for scanning the manuscript.

With this configuration, the reading region can be divided along the sub scanning direction. Therefore, the partial regions can be easily set.

### Application Example 3

In the image reading apparatus according to the Application Example, it is preferable that the region division unit divide the reading region in accordance with a division direction directed along a main scanning direction perpendicular to the sub scanning direction in addition to the sub scanning direction.

With this configuration, the reading region can be divided along the sub scanning direction and the main scanning direction. Therefore, the partial regions can be easily set.

### Application Example 4

In the image reading apparatus according to the Application Example, it is preferable that the image reading apparatus further include a display unit which displays an entire image obtained by reading the reading region at a predetermined resolution by the image reading unit. It is also preferable that the division direction be directed with respect to the entire image displayed on the display unit.

With this configuration, the reading region can be explicitly divided. Therefore, the partial regions can be easily set.

### Application Example 5

In the image reading apparatus according to the Application Example, it is preferable that the image reading apparatus include a memory unit which holds data of the manuscript image read by the image reading unit, an image processing unit which cuts out an image included in the partial regions by performing an image processing on data of the manuscript image held by the memory unit, and a communication unit which transmits data of the cut-out image to another apparatus.

With this configuration, the image included in each of partial regions can be cut out from the read manuscript image and transmitted to another apparatus.

### Application Example 6

An image reading system according to the Application Example is an image reading system in which an image reading apparatus and a client device are communicably connected. The image reading apparatus divides a reading region on which a manuscript is placed into a plurality of partial regions, reads each of manuscript images from each of the partial regions on conditions set for each of the partial regions, transmits data of the read manuscript images to the client device. In the image reading system, the client device receives data of the manuscript images transmitted from the image reading apparatus, and displays the manuscript images indicated by data of the received manuscript images so as to be editable.

With this configuration, a reading region where the image reading unit reads a manuscript image is divided into a plurality of partial regions and a condition on which the manuscript image is read is set for each of the partial regions. Accordingly, the manuscript image is read on the reading conditions set for each of the partial regions with one reading operation. Therefore, a manuscript in which documents and pictures are mixedly present is effectively read and a user's labor can be reduced.

### Application Example 7

An image reading method according to the Application Example includes a placement step for placing the manuscript on a reading region, a setting step for dividing the reading region into a plurality of partial regions, and setting a condition on which the manuscript image is read for each of the partial regions, and a reading step for reading the manuscript image on the conditions depending on the scanned partial regions.

With this method, a region in which a manuscript image is read is divided into a plurality of partial regions and a condition on which the manuscript image is read is set for each of partial regions. Accordingly, the manuscript image is read on the reading conditions set for each of the partial regions with one reading operation. Therefore, a manuscript in which documents and pictures are mixedly present is effectively read and a user's labor can be reduced.

### BRIEF DESCRIPTION OF THE DRAWINGS

The invention will be described with reference to the accompanying drawings, wherein like numbers reference like elements.

FIG. 1 is a block diagram illustrating a schematic configuration of a scanner device according to a first embodiment of the invention.

FIG. 2 is a view illustrating the scanner device according to the first embodiment of the invention.

FIG. 3 is a flowchart illustrating a flow of a reading process of a manuscript in the scanner device according to the first embodiment of the invention.

FIG. 4 is a view illustrating a scanner device according to a second embodiment of the invention.

FIG. 5 is a view illustrating a scanner device according to a third embodiment of the invention.

### DESCRIPTION OF EXEMPLARY EMBODIMENTS

Hereinafter, an image reading apparatus according to the invention will be described with reference to drawings.

### First Embodiment

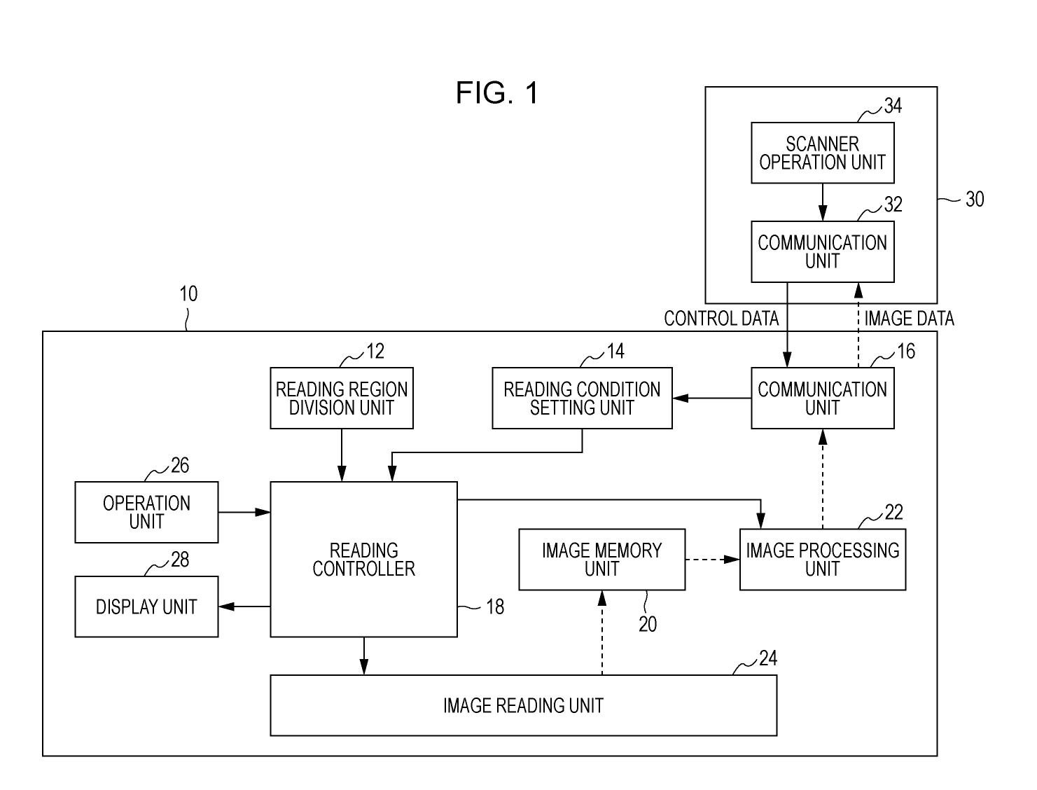

FIG. 1 is a block diagram illustrating a schematic configuration of a scanner device 10 as one image reading apparatus. In FIG. 1, solid line arrows indicate flows of control data and dashed line arrows indicate flows of image data. A computer 30 is connected to the scanner device 10. The computer 30 is a client device which makes a direction of image reading. In the first embodiment, it is assumed a pull scan function in the scanner device 10 to be used. The pull scan function is a function in which the scanner device 10 starts to read a manuscript in accordance with a reading direction transmitted based on an operation relating to reading of the manuscript by a user on the computer 30 and transmits image data of the read manuscript to the computer 30.

The computer 30 includes a scanner operation unit 34 which receives an operation direction with respect to the scanner device 10 from a user, and a communication unit 32 which communicates with the scanner device 10. The scanner operation unit 34 is a unit including a user interface and a scanner driver and is configured with software.

The scanner device 10 includes a reading region division unit 12, a reading condition setting unit 14, a communication unit 16, a reading controller 18, an image memory unit 20, an image processing unit 22, an image reading unit 24, an operation unit 26 and a display unit 28.

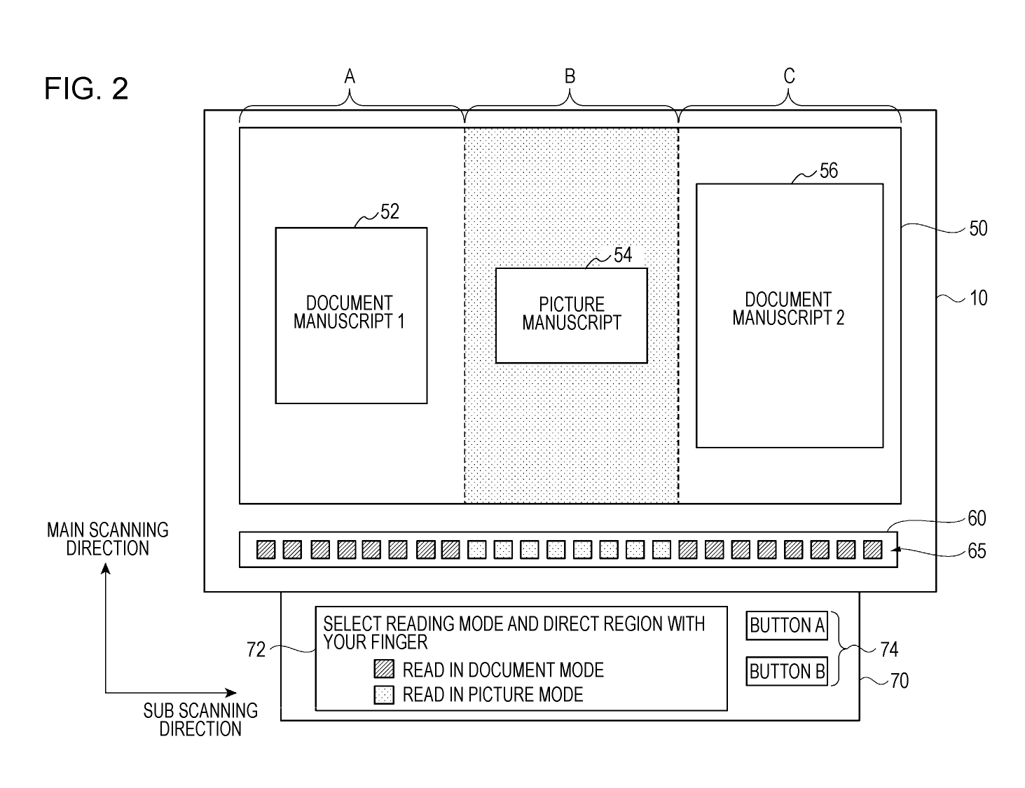

The image reading unit 24 includes a carriage and a guide mechanism both of which are not shown. The carriage has an illumination lamp, an optical system, a Charge Coupled Device (CCD) and the like. The guide mechanism makes the carriage move in one direction (sub scanning direction). The image reading unit 24 optically reads figures, pictures, characters, and the like of a manuscript placed on a reading region which can be read on a manuscript table 50 (see, FIG. 2) on a predetermined reading condition with a scanning operation. At this time, the image reading unit 24 reads the manuscript in accordance with a direction from the reading controller 18. Further, the image reading unit 24 transmits the read manuscript image to the image memory unit 20. As a reading system, a flat bed system in which a fixed manuscript is scanned in each of the sub scanning direction and a CCD arrangement direction (main scanning direction) which is perpendicular to the sub scanning direction is employed. Further, the reading condition is set for each of previously specified regions of the reading region, and is directed from the reading controller 18 depending on reading positions.

The image memory unit (memory unit) 20 is a memory which holds the manuscript image read by the image reading unit 24 and is formed with a memory from which the manuscript image can be read-out at fast speed, such as a semiconductor memory. The image memory unit 20 has a capacity of such size that image data obtained by reading a maximum region which can be read by the image reading unit 24 at a maximum resolution can be stored.

The image processing unit 22 reads image data stored in the image memory unit 20 in accordance with a direction from the reading controller 18 and cuts out a manuscript portion from an image so as to convert the cut-out image data to a predetermined format decodable at the computer 30 side. The converted data is transmitted to the computer 30 through the communication unit 16.

The reading region division unit (region division unit) 12 has a function for dividing a reading region in accordance with a direction by a user. Further, the reading condition setting unit 14 has a function for setting a reading condition for each of divided reading regions in accordance with a direction by a user. Information relating to division of the reading region set by the reading region division unit 12, and information relating to the reading condition set by the reading condition setting unit 14 are transmitted to the reading controller 18. In the first embodiment, the reading region division unit 12 is supposed to be a touch panel 60 which is arranged between the manuscript table 50 and an operation unit 70 so as to be in parallel with the sub scanning direction, as shown in FIG. 2. A user touches a desired position on the touch panel 60 with finger and presses operation buttons 74. Therefore, the user can arbitrarily divide a reading region on the manuscript table 50.

The reading condition setting unit (condition setting unit) 14 makes it possible to set a desired condition for each of the divided reading regions as follows. That is, a user presses the operation button 74 to select a reading condition from reading conditions displayed on the display panel 72 of the operation unit 70. For example, in FIG. 2, the reading region is divided into three regions. A document mode is set to a region A and a region C and a picture mode is set to a region B. At this time, low resolution which is appropriate for reading documents is set to the document mode and high resolution which is appropriate for reading pictures is set to the picture mode. It is to be noted that although a case where there are three manuscripts is illustrated in FIG. 2, the same holds for a case where documents and pictures are laid out on one sheet.

In the first embodiment, region division marks 65 corresponding to the reading regions are displayed on the touch panel 60. Display colors or display patterns of the region division marks 65 change when fingers move on the touch panel 60 so that the reading regions are changed. The display colors or display patterns are made different depending on the reading conditions. To be more specific, the reading regions have rectangular shapes and length in the sub scanning direction is directed by the touch panel 60 so as to define the rectangular shapes. Further, a reading mode is determined with respect to each of the defined rectangular shapes with the operation buttons 74 so as to set a reading condition for each of the reading regions. Therefore, a user can visually recognize the set reading regions and reading conditions easily.

Note that the reading condition is not limited to the switching of the resolution modes such as a document mode and a picture mode and may be set by specifying a numerical value of resolution, switching black and white/color/gray, switching background colors, setting image data formats, or the like.

The reading controller (controller) 18 directs the image reading unit 24 to read a manuscript image on reading conditions depending on the reading regions scanned by the image reading unit 24. The display unit 28 displays necessary information for a user when the reading region is divided and the reading conditions are set. Further, the operation unit 26 is operated by a user when the reading region is divided and the reading conditions are set.

FIG. 2 is a view illustrating the manuscript table 50 and the operation unit 70 of the scanner device 10. When a reading direction is transmitted from the computer 30 in a state where a reading region is divided and reading conditions are set as shown in FIG. 2, the image reading unit 24 scans a manuscript on a region A in a document mode at first to read an image of a document manuscript 1(52). Next, the image reading unit 24 scans a manuscript on a region B in a picture mode to read an image of a picture manuscript (54). Further, the image reading unit 24 scans a manuscript on a region C in a document mode to read an image of a document manuscript 2(56) so that a series of reading processings is ended. Manuscript portions are cut out from each of the image including the document manuscript 1(52), the image including the picture manuscript (54) and the image including the document manuscript 2(56) read by the above processings, and then, the cut-out images are transmitted to the computer 30. Then, each image data of the document manuscript 1(52), the picture manuscript (54) and the document manuscript 2(56) is displayed on the display of the computer 30 so as to enable a user to edit and store each image data if needed.

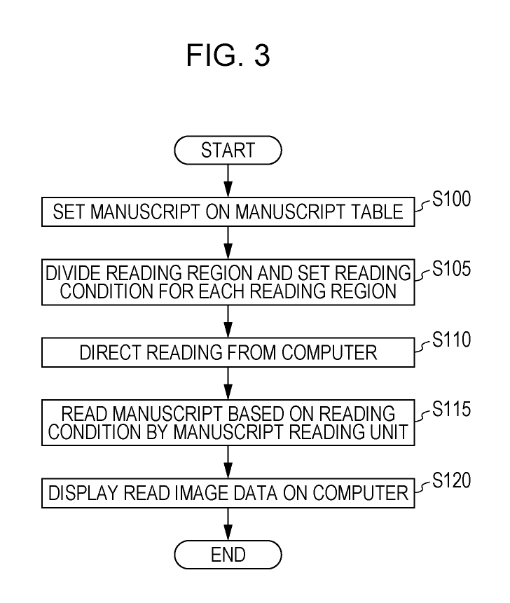

FIG. 3 is a flowchart illustrating a flow of a reading process of a manuscript in the scanner device 10. At first, a manuscript is set on the manuscript table 50 by a user (step S100) (placement step). Subsequently, a reading region is divided by a user and a reading condition is set for each of the divided reading regions (step S105) (setting step).

Next, the computer 30 is operated by a user so that a reading direction is transmitted to the scanner device 10 (step S110). Subsequently, the scanner device 10 sequentially reads manuscripts based on the reading conditions set for each of the reading regions (step S115) (reading step).

Finally, the scanner device 10 performs an image processing on each image data of the read manuscripts, and then, transmits the obtained image data to the computer 30. The computer 30 displays each of the received image data (step S120), and each image data is edited or stored if needed.

With the above processings, for example, in the case where a manuscript in which pictures and documents are mixedly present is read, the pictures are read in detail and the documents are read fast. Therefore, the manuscript can be effectively read.

### Second Embodiment

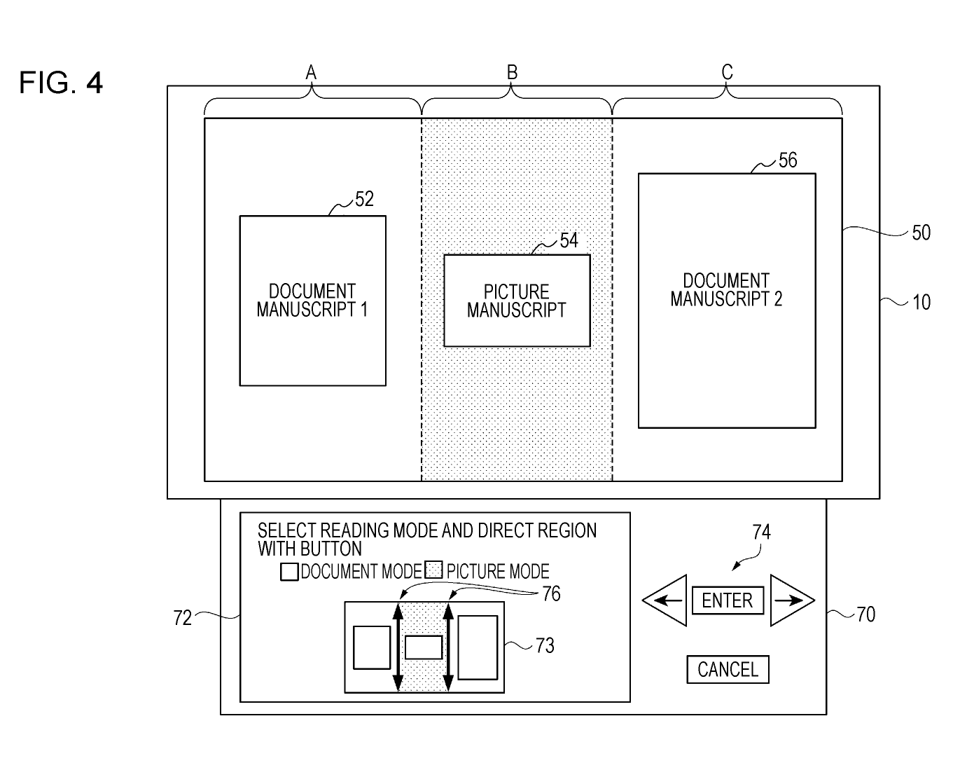

Next, the second embodiment of the invention will be described with reference to FIG. 4 illustrating the manuscript table 50 and the operation unit 70 of the scanner device 10. It is to be noted that same reference numerals denote the same components as those which have been already described, and description thereof is not repeated. In the first embodiment, the reading region is directed by the touch panel 60 which is arranged in parallel with the sub scanning direction. However, in the second embodiment, when the reading region is set, the entire face of the manuscript table 50 is read at low resolution at first, and the read entire image (thumbnail image) 73 at low resolution is displayed on the display panel 72. A user divides the reading region by moving positions of partition marks 76 with the operation buttons 74. At this time, the partition marks 76 are displayed on the display panel 72 so as to be superimposed with the entire image 73. Then, the user sets a reading condition for each of the regions divided by the operation buttons 74.

With such method, a manuscript can be effectively read and a reading region can be explicitly set.

### Third Embodiment

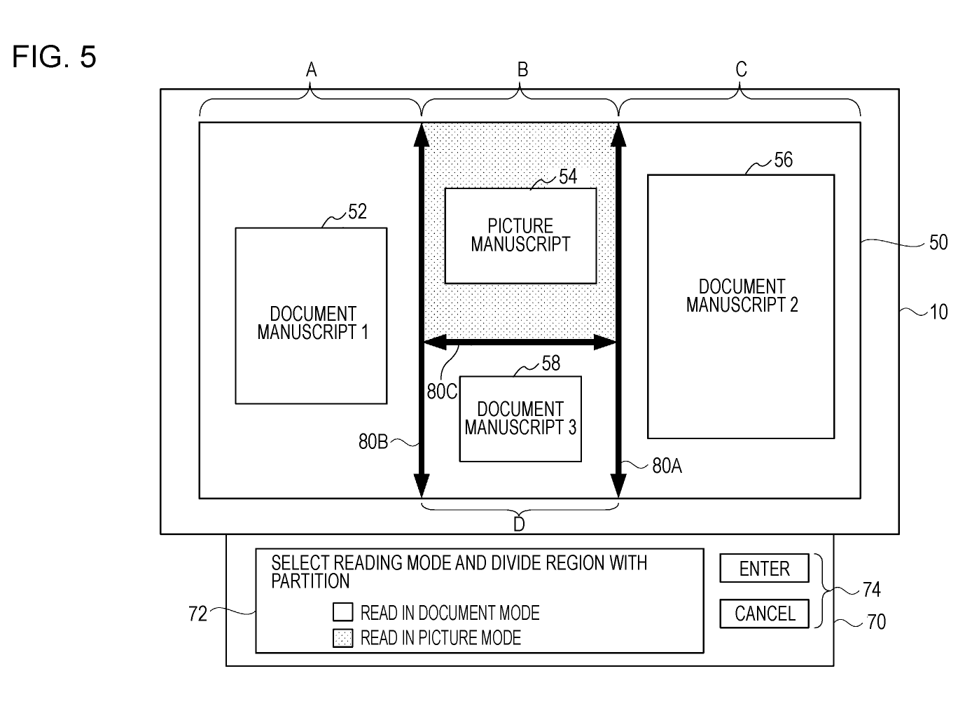

Next, the third embodiment of the invention will be described with reference to FIG. 5 illustrating the manuscript table 50 and the operation unit 70 of the scanner device 10. In the third embodiment, a user arranges partition plates 80A through 80C on the manuscript table 50 so as to set reading regions. The partition plates 80A through 80C may be formed with paper, plastic, metal or the like and a magnetic sensor or the like may be embedded in the partition plate 80A through 80C. The image reading unit 24 detects the partition plates 80A through 80C, and the reading regions are set based on positions of the detected partition plates 80A through 80C.

Further, in the first embodiment and the second embodiment, the reading region is partitioned so as to be divided along the sub scanning direction. However, in the third embodiment, the reading region can be divided along the main scanning direction in addition to the sub scanning direction by arranging such as the partition plate 80C. As a result, the reading region is divided into a B region and a D region along the main scanning direction. The document manuscript 3(58) in the D region is read in the document mode and the picture manuscript 54 in the B region is read in the picture mode. To be more specific, the image reading unit 24 reads a manuscript at a constant resolution with respect to the main scanning direction and the image processing unit 22 performs an image processing in modes depending on the reading positions in the main scanning direction. This makes it possible to read in different modes with respect to the main scanning direction.

With this method, a manuscript can be effectively read.

The embodiments of the invention have been described with reference to drawings. Detail configurations of the invention are not limited to these embodiments and changes in design without departing from a range of the scope of the invention are encompassed in the invention. For example, the reading region may be directed to be divided and the reading condition may be directed to be set for each of the reading regions from application software on the computer 30. Further, in the scanner device 10, the reading region may be divided and a reading condition may be set for each of the reading regions not only in the pull-scan mode but also in a push-scan mode.

In addition, the reading region is not limited to a rectangular shape and may have any shapes. For example, regions of polygonal shape or circular shape may be read as color images and other regions may be read as monochrome images. Further, an apparatus which executes the above methods may be realized with a single device or realized by combining a plurality of devices such as Multifunction Peripheral (MFP) and may include various types of modes.

What is claimed is:

1. An image reading apparatus comprising:
an image reading unit which reads a manuscript image by optically scanning a manuscript placed on a reading region;
a region division unit which divides the reading region into a plurality of partial regions in accordance with a division direction directed along a sub scanning direction to which the image reading unit moves for scanning the manuscript and a division direction directed along a main scanning direction perpendicular to the sub scanning direction;
a condition setting unit which sets a condition on which the image reading unit reads the manuscript image for each of the partial regions; and
a controller which directs the image reading unit to read the manuscript image on the conditions depending on the partial regions being scanned by the image reading unit.

2. The image reading apparatus according to claim 1, further comprising a display unit which displays an entire image obtained by reading the reading region at a predetermined resolution by the image reading unit,
wherein the division direction is directed with respect to the entire image displayed on the display unit.

3. The image reading apparatus according to claim 1, further comprising:
a memory unit which holds data of the manuscript image read by the image reading unit;
an image processing unit which cuts out an image included in a partial region by performing an image processing on data of the manuscript image held by the memory unit; and
a communication unit which transmits data of the cut-out image to another apparatus.

4. An image reading method which reads a manuscript image by optically scanning a manuscript, comprising:
placing the manuscript on a reading region;
setting a condition on which the manuscript image is read for each of the partial regions by dividing the reading region into a plurality of partial regions; and
reading the manuscript image on the conditions depending on the scanned partial regions,
wherein in the setting, the reading region is divided in accordance with a division direction directed along a sub scanning direction to which the image reading unit moves for scanning the manuscript and a division direction directed along a main scanning direction perpendicular to the sub scanning direction.
